(19) United States
(12) Patent Application Publication
(10) Pub. No.: US 2015/0127501 A1
(43) Pub. Date: May 7, 2015

(54) System and Method for Capturing Exit Transaction Data

(71) Applicant: Strategic Exits Corp., Coquitlam (CA)

(72) Inventor: Basil Peters, Coquitlam (CA)

(73) Assignee: Strategic Exits Corp., Coquitlam (CA)

(21) Appl. No.: 14/074,386

(22) Filed: Nov. 7, 2013

(51) Int. Cl. G06Q 40/00

(52) U.S. Cl. CPC G06Q 40/12
USPC 705/30

(57) ABSTRACT

A system and method are provided for obtaining exit transaction data. The method comprises providing a first user interface for entering the exit transaction data from a first source; enabling entry of a first portion of the exit transaction data; enabling at least one additional portion of the exit transaction data to be obtained from a second source using a second user interface; receiving a first entry corresponding to the first portion of data; receiving at least one second entry corresponding to the at least one additional portion of the exit transaction data; and storing the first entry and at least one second entry in association with a particular transaction.

### TECHNICAL FIELD

The following relates to systems and methods for capturing exit transaction data.

### DESCRIPTION OF THE RELATED ART

There is an important need to capture the valuations of private company merger and acquisition (M&A) transactions (i.e. one form of “exit”), since these valuations are the ultimate economic output of both the entrepreneurial and equity investment processes. Moreover, this transaction data is an important input to econometric research on the new entrepreneurial economy, ways investors can maximize returns, and how governments can change policy to foster overall economic growth.

Gathering exit valuation data was easier in the past because a larger percentage of the companies that had exits (i.e. M&A transactions or initial public offerings (IPOs)) were financed by venture capital funds and other professional investment organizations. Today, a great many companies are financed entirely by friends, family, angel, and other non-professional investors. There is also a much higher probability today of an M&A exit as compared to an IPO.

Venture capital funds and other professional investors needed to accurately track their portfolio exit transactions to be able to provide accurate reporting to their investors or limited partners. These investors typically have teams of professional staff to provide this information. In contrast, friends, family, angel or other types of non-professional investors do not need to track portfolio performance and typically do not have professional staff available to provide data to econometric research organizations.

Currently, it is increasingly likely that a company will be started and then either completely bootstrapped (i.e. grown without any capital from investors) or entirely financed by friends, family and angel investors. The most likely type of exit transactions for these companies is an acquisition (e.g., an M&A transaction or private exit).

In the past, a larger percentage of companies achieved an exit through an IPO. In IPO transactions, full and detailed disclosures are required for the entire history of the company. Companies that have IPO exits provide a very complete dataset from the company's inception to the IPO and this information is publically available. This public disclosure information provided much of the information on exits that were used in analyses performed in the past.

In the past, companies would also often go through several stages of financing from professional investors. For example, it was not unusual for companies to be financed for one or two decades before achieving an exit. Currently, the situation is quite different, especially in the high tech sector. For example, now it is quite common for companies to be founded, possibly financed and achieve an exit within just a few years after being founded.

This new reality creates a number of challenges in capturing the exit transaction values. In the very large majority of company exits, there are no venture capital funds or professional investors involved and very little public information about the private exit transactions.

In the past, data on exits was usually gathered by trusted organizations that were familiar to the professional associations of venture capital funds or other types of professional investors. These organizations developed personal relationships with the much smaller number of professional investment organizations, gained their trust, and convinced them to complete detailed questionnaires or spreadsheets about each of their portfolio companies. The professional investors were usually pleased to provide this information, because the aggregate data was valuable to them in understanding how their organizations were performing, and valuable in helping the industry develop better investment methodologies.

Exit data is also usually provided without any economic compensation, i.e. it is typically provided at no cost by the data provider. The earlier forms of surveys often required many days of effort to complete. Not only did the surveys require a significant investment of time, the level of expertise required to complete these meant that they usually had to be done by the chief financial officer (CFO), VP Finance, or someone of a similar seniority in the professional investment organization. The imbalance between the high cost of providing the data and the lack of compensation meant that only a very few data points were gathered.

Recently, some organizations have tried to gather data on exit transactions by using similar methods with friends, family, and angel investors. They have also attempted to gather this information from angel investor organizations and groups. This has largely been unsuccessful because of the lack of accurate recordkeeping, and because very few of the investors or groups of investors have the staff, and motivation, required to complete the surveys.

Moreover, in the past, the identities of both the data provider and data gatherer were well known to each other, verifiable and trusted. The data gatherers knew that the professional funds providing the information could be relied upon to provide highly accurate information (i.e. because of the stringent requirements required by their agreements with their investors). This meant that traditionally a single data provider could be relied upon to provide complete and highly accurate information.

Currently, the situation is very different. Very often the identities of the data gatherer and data provider are completely unknown to each other. A further complication is that the majority of friends, family angel and other informal investors do not necessarily have accurate, detailed records. This means that for many of the data samples currently available there can be a high degree of uncertainty in the information and the data is rarely complete. Also, because the identities are not known it may not be possible to verify the information or to have a sufficiently high degree of comfort that the information is accurate.

An even further complication is that much of the information available on exit valuations today is second or third hand. This means that the person who is willing to provide the information may have heard it verbally from someone who themselves may have heard it from somebody else actually involved with the transaction. This data is often referred to as “rumored” data. In most of the current exits this may be the best information available.

In the past, research organizations needed to make a face-to-face, or telephone, appeals to the senior partners in the professional investment organizations to convince them to contribute their data. This type of real time communication was necessary to convince the decision makers to allocate the time from their staff to complete the data collection process.

With professional investment organizations, a single contributor usually had all of the data required on a particular exit transaction. Accordingly, previous data collection systems were designed to capture all of the data on a particular exit transaction from a single contributor. These data sets would include everything from the year the company was founded, its entire history of capital transactions, exit valuation, exit valuation comparables, professionals involved in the transaction and exit transaction date and valuation. These surveys might often request, and obtain, dozens of data points on each individual transaction from a single data contributor.

A significant impediment to capturing exit transaction data is non-disclosure agreements. In most transactions the selling company and shareholders will be bound by a non-disclosure agreement prohibiting them from disclosing some, or all, of the information related to the transaction. In some situations, the data gathering organization would still be able to capture the data by exchanging a non-disclosure agreement with the data provider. This added considerably more time to the process, but more importantly this additional hurdle often meant that the data contributor would decide not contribute the data at all.

It is an object of the present application to address at least one of the above-mentioned challenges.

### SUMMARY

In one aspect, there is provided a method of obtaining exit transaction data, the method comprising: providing a first user interface for entering the exit transaction data from a first source; enabling entry of a first portion of the exit transaction data; enabling at least one additional portion of the exit transaction data to be obtained from a second source using a second user interface; receiving a first entry corresponding to the first portion of data; receiving at least one second entry corresponding to the at least one additional portion of the exit transaction data; and storing the first entry and at least one second entry in association with a particular transaction.

In another aspect, there is provided a system for obtaining exit transaction data, the system comprising a processor, at least one memory element, and at least one communication interface, the at least one memory element comprising computer executable instructions executable by the processor to: provide a first user interface for entering the exit transaction data from a first source; enable entry of a first portion of the exit transaction data; enable at least one additional portion of the exit transaction data to be obtained from a second source using a second user interface; receive a first entry corresponding to the first portion of data; receive at least one second entry corresponding to the at least one additional portion of the exit transaction data; and store the first entry and at least one second entry in association with a particular transaction.

In yet another aspect, there is provided a computer readable storage medium comprising computer executable instructions for obtaining exit transaction data, the computer executable instructions comprising instructions for: providing a first user interface for entering the exit transaction data from a first source; enabling entry of a first portion of the exit transaction data; enabling at least one additional portion of the exit transaction data to be obtained from a second source using a second user interface; receiving a first entry corresponding to the first portion of data; receiving at least one second entry corresponding to the at least one additional portion of the exit transaction data; and storing the first entry and at least one second entry in association with a particular transaction.

### BRIEF DESCRIPTION OF THE DRAWINGS

Embodiments will now be described by way of example only with reference to the appended drawings wherein:

FIG. 1 is a block diagram of a transaction data capture system, transaction database, and data capture channels;

FIG. 2 is a block diagram of an example of a user device for providing transaction data;

FIG. 3 is a block diagram of an example configuration for a transaction data capture system;

FIG. 4 is a flow diagram illustrating various exemplary data capture input mechanisms;

FIG. 5 is a flow diagram illustrating an example of a tiered data capture process;

FIG. 6 is a flow chart illustrating computer executable instructions that may be performed in initiating a data capture campaign;

FIG. 7 is a flow chart illustrating computer executable instructions that may be performed in capturing data from one or more data contributors;

FIG. 8 is a flow chart illustrating computer executable instructions that may be performed in executing a tiered data capture process;

FIG. 9 is a flow chart illustrating computer executable instructions that may be performed in enabling a tiered data capture process on a data contributor user device;

FIG. 10 is a screen shot of an example of a user interface for capturing exit transaction data;

FIG. 11 is another screen shot of an example of a user interface for capturing exit transaction data;

FIG. 12 is another screen shot of an example of a user interface for capturing exit transaction data;

FIG. 13 is another screen shot of an example of a user interface for capturing exit transaction data; and

FIG. 14 is another screen shot of an example of a user interface for capturing exit transaction data.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

An improved solution for gathering data on exit transactions (e.g. M&A transactions or private company sales, etc.) is herein presented using a system that is configured to gather more complete and accurate data on exit transactions that addresses the aforementioned difficulties in the current economic environment. The system described herein utilizes a tiered data capture approach using various newly available data capture channels and input methodologies to not only increase the amount of information gathered, but to reduce the burden on any individual data contributor.

The system dramatically reduces the time burden (and associated economic cost) of gathering exit transaction data from friends, family, angel and other informal investors by reducing the time required to contribute to the data gathering process from a matter of days to a matter of minutes by incorporating convenient and user friendly data gathering methods employing current communication and data collection technologies.

Whereas one of the most significant impediments to gathering this data previously had been the considerable cost of completing surveys employed by the data gatherers. The system described herein mitigates this cost by enabling data contribution using familiar and convenient communication channels, while employing a tiered data capture approach.

It can be appreciated that although the following examples relate to exit transaction data, the principles discussed herein may equally apply to methods and systems for obtaining any type of transaction data.

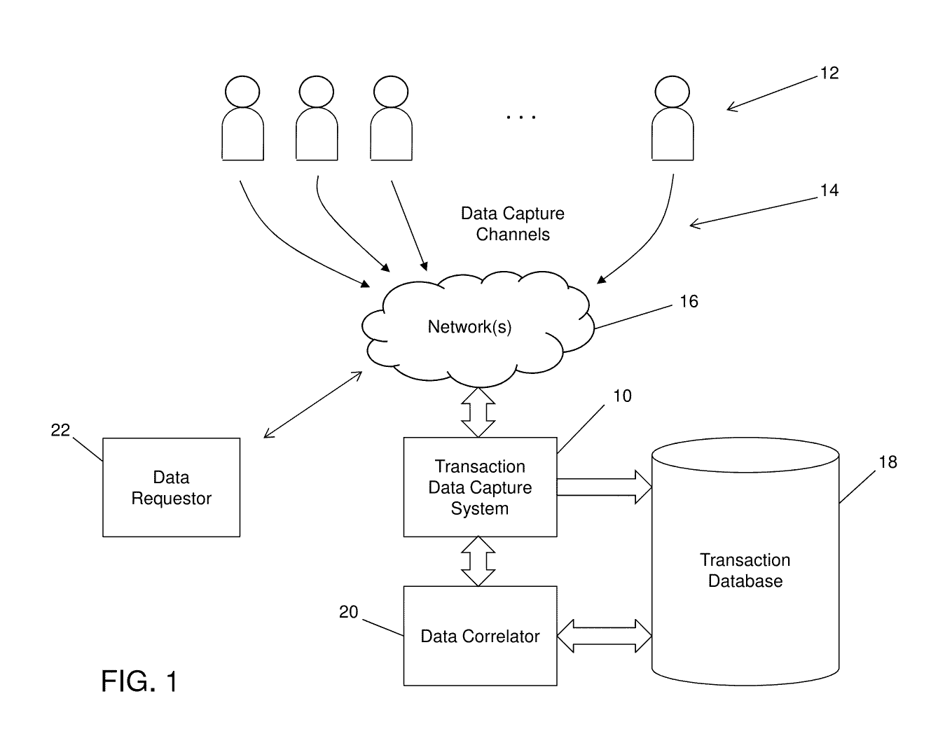

Turning now to FIG. 1, a transaction data capture system 10 (hereinafter referred to as the “system 10” for brevity) is shown which is operable to communicate with, and to obtain, exit transaction data from one or more data contributors 12 via various data capture channels 14 which utilize at least one network 16 with which the system 10 is communicable. The system 10 is coupled to or otherwise includes or has access to a transaction database 18 for storing captured exit transaction data and, if applicable, information concerning data contributors 12, copies of confidentiality agreements with contributors 12, etc. The system 10 may also utilized or otherwise include or have access to a data correlator 20, which is programmed or configured to perform data correlation methods, algorithms, and processes to process data gathered by the system 10 in order to correlate, validate, and refine such data to provide meaningful results. Also shown in FIG. 1 is a data requestor 22 which represents any individual or entity that is capable of communicating with the system 10 in order to obtain a manifestation of the stored data from the database 18, e.g., raw data, reports, etc.

The system 10 is configured to incorporate multiple different input technologies and corresponding data capture channels 14, e.g., http and https (browser or app), email, short message service (SMS), instant messaging (IM), social media (e.g., Twitter, Facebook, LinkedIn, RSS, etc.), as well as any future channel by which a data contributor can interact with the system 10. It has been found that leveraging these existing and familiar data channels reduces the burden on the data contributor and provides additional opportunities to entice users to contribute exit transaction data, and removes the requirement for an established relationship between the data contributor and data gatherer, as described in further detail below.

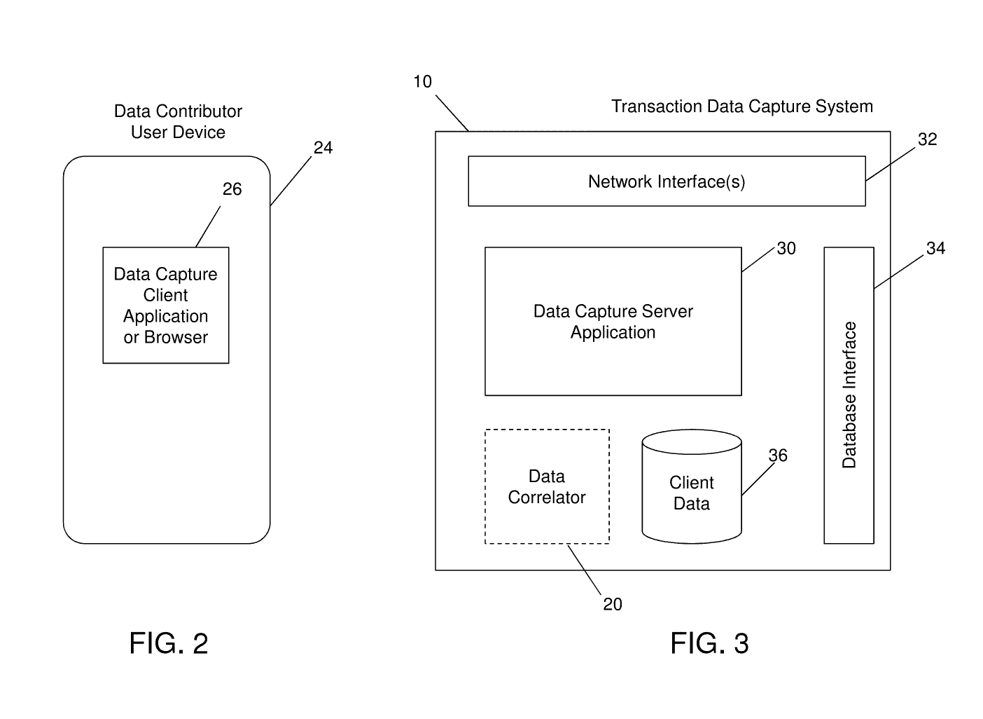

The data contributor 12, in addition to utilizing familiar and convenient input methodologies also further benefits from the ability to participate in the data gathering process using familiar and convenient user devices, such as smart phones, tablet computers, laptops, desktop computers, and other communication-enabled computing devices. An example of a data contributor user device 24 is shown in FIG. 2, which in this example represents a smart phone having a data capture client application or browser 26 which enables the user to be presented with and enter information and data and to communicate with the system 10.

An example of a configuration for the system 10 is shown in FIG. 3. The system 10 includes a data capture server application 30, which may be configured, programmed, or otherwise operable to initiate and conduct data gathering processes and campaigns, receive and process requests for confidentiality agreements with data contributors 12, store data in the transaction database 18, communicate with the data correlator 20 to process the stored data, handle requests for data from data requestors 22, among other things. The system 10 includes one or more network interfaces 32 to enable the data capture server application 30 to communicate with data contributors 12 and data requestors 22 via the one or more networks 16 shown in FIG. 1. The system 10 also includes a database interface 34 for communicating with the transaction database 18 and any programs running thereon to add and retrieve data. It can be appreciated that the transaction database 18 may, in other embodiments be integral to the system 10, or may be communicable using one of the network interfaces 32. As such, the configuration shown in FIG. 3 is illustrative only.

In the example shown in FIG. 3, the data correlator 20 is shown in dashed lines to illustrate that the data correlator 20 may also be integral to the system. It can therefore be appreciated that the modular representation shown in FIG. 1 is also for illustrative purposes only and that various configurations are possible according to the principles discussed herein. Also shown in FIG. 3 is client data 36, which may be used by the system 10 to store login details and other information concerning specific data contributors 12, as well as copies of confidentiality agreements associated with specific data contributors 12. However, it will be appreciated that in at least some embodiments, the system 10 may obtain data anonymously and therefore it is not a requirement of the system 10 that client data 36 be stored for every data contributor 12.

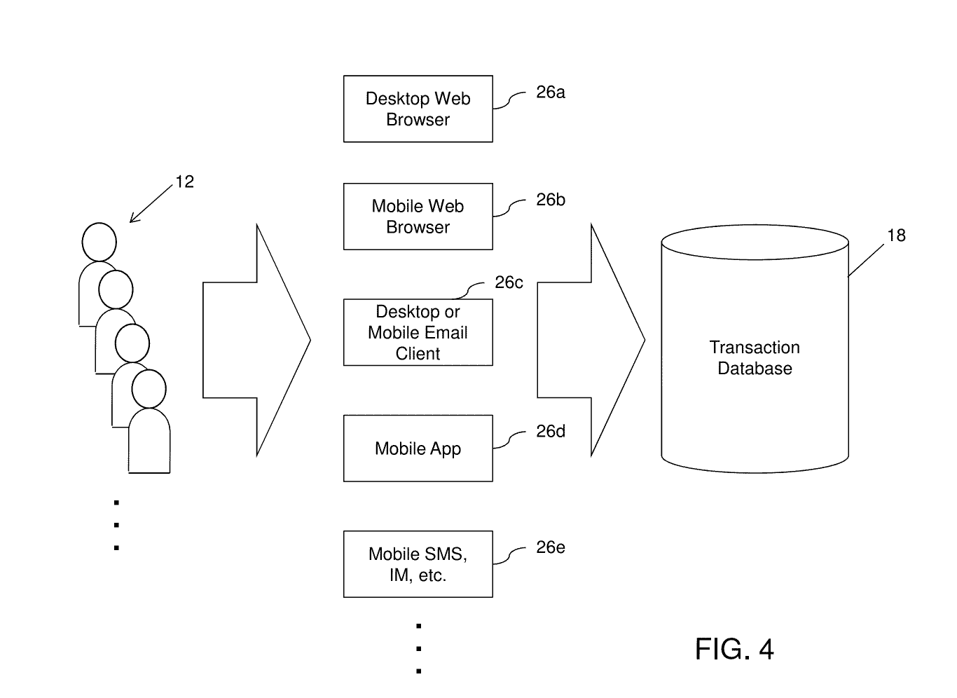

FIG. 4 illustrates various input mechanisms 26 that may be employed by the data contributors 12 in order to input exit transaction data to the transaction database 18 via the system 10 (not shown in FIG. 4 for ease of illustration). The examples illustrated in FIG. 4 include without limitation, a web browser 26a for a desktop computer, a mobile web browser 26b (e.g. used by a smart phone or tablet computer), a desktop or mobile email client 26c (e.g. to obtain responses via an email reply or embedded structure), a mobile application 26d that is customized for the data capturing process and can be used repeatedly for repeat contributors 12, and other mobile channels 26e such as SMS, IM, social media, etc. as discussed above. It can be appreciated from FIG. 4 that the system 10 enables various and multiple data capture channels 14 to not only make the process more user friendly and convenient, but also to increase the likelihood that data contributors 12 can be reached and to increase the number of data contributors 12 that can be reached.

As discussed above, previous data capture methods were rigid and usually required every data contributor to provide the entire set of data related to each exit transaction. This created a very high time threshold to provide data on just one exit transaction. The system 10 described herein solves one of the most difficult aspects of exit data gathering, which is identifying the companies that have actually exited, by allowing the contributor 12 to provide as little as only the company name and exit value. It can be appreciated that this can overcome the “needle in the haystack” problem encountered when researchers attempt to find exit data by first having to search through the universe of all companies, or publically disclosed information, in hopes of learning about companies that have exited. Once a single submission on an exit transaction has been received the system 10 may then proceed to more precisely target requests to individuals with known associations with the company that exited. It has been recognized that this layered or “tiered” collection approach can increase the probabilities that any given exit transaction is captured by splitting the effort amount a number of data contributors.

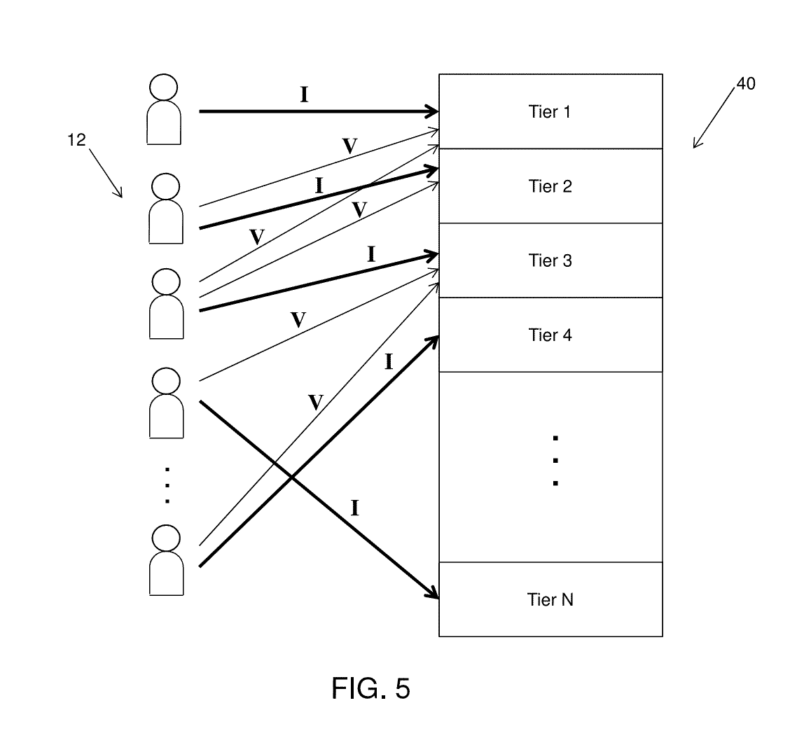

Turning now to FIG. 5, such a tiered data gathering process is illustrated in one example. In this example, the exit transaction data 40 that is sought is broken down into a plurality of tiers, i.e. Tier 1, Tier 2, Tier 3, Tier 4, . . . , Tier N in this example. The data 40 may be broken down in any suitable manner, one example of which will now be described. The Tier 1 data can include the company name and exit value (i.e. selling price), with Tier 2 being the identity of the data contributor 12. By having the identity of the data contributor 12 be a lower tier than Tier 1, the system 10 would still be able to obtain samples of (or validations for) at least the basic data in Tier 1 while allowing some contributors to be anonymous. Further tiers may then be used to gather more specific data. For example, Tier 3 may include the exit date, which would require a somewhat more intimate knowledge of the transaction. Tier 4 may then request information such as price per share, previous financing 1 valuation or price per share, previous financing 2 valuation or price per share, up to N financings that may have occurred. Various other layers may be generated and presented to different contributors 12. For example, a Tier 5 could include information such as gathering information on the types of investors, e.g. friends and families, angel investors, venture capital funds, other (i.e. allow user to specify using input boxes).

FIG. 5 also illustrates that data contributors 12 can be used to both provide data in a particular tier initially, and to validate already submitted data. For example, the uppermost contributor 12 may initially provide the Tier 1 data (as illustrated using an “I”). The next contributor 12 then both validates the Tier 1 data already submitted (as illustrated using a “V”) and provides the initial Tier 2 data. The next contributor 12 then both validates one or more of the Tier 1 and Tier 2 data (validation of both shown for illustrative purposes only), and contributes the initial Tier 3 data. The other contributors 12 shown in FIG. 5 also illustrate that any tier can be validated and/or initialized by a particular contributor and that the tiered data 40 can be built in any order depending on the availability of the information and responsiveness of the particular contributors 12.

It can be appreciated that the tiered data capturing approach utilized by the system 10 also addresses the problem of selection bias created by the economic burden of previous systems by reducing the burden to as little as a matter of minutes, thereby reducing the probability that smaller transactions, more likely to be funded by non-professional investors, are captured.

It can also be appreciated that the system 10 addresses an inherent problem in the current economy where today there is likely no single individual who necessarily has a complete set of data on any one exit transaction. The system 10 is configured, as shown in FIGS. 1, and 3-5 to aggregate information from a large number of data contributors and to enable it to be correlated to provide a more accurate result. In the past, a single data set could be relied upon because it was being provided by a professional investment organization which had to comply to rigid reporting standards. The system 10 is designed to capture data in layers or tiers, and for multiple contributors 12, and to cross-correlate the data to eliminate the inherent inaccuracies in data provided by non-professional, or informal, investors or third parties who may have only received the data verbally and are relying on their memories.

The system 10 also can reduce the economic burden on each contributor by breaking the total data gathering process into small elements which can be executed asynchronously by a large number of individuals. The data 40 can also be gathered asynchronously in layers by initially only capturing the two primary data points (e.g., the name of the company and the exit transaction value) and then later adding additional information such as the previous financing valuations, number of shares and return to investors, etc.. The system 10 also employs multiple technologies and social media channels to enable a crowd-based knowledge gathering process.

As discussed above, the system 10 may include or utilize a data correlator 20 to improve accuracy in the data gathered, which may be important when several or dozens of contributors 12 are relied upon to build the data 40. The system 10, unlike earlier data gathering techniques, is designed to capture multiple data points for each exit transaction. The system 10 may then calculate a confidence interval based on the number and distribution of data points collected. This provides a unique insight into the degree of accuracy of each data element. It can be appreciated that the data correlator 20 may be configured to utilize various available statistical algorithms and methodologies in order to process the gathered data. For example, various methods may be employed to determine means and variances, exclude outliers, and apply statistical filtering to “clean” the data.

The various data contributors 12 can interact with the system 10 in different ways. For example, the system 10 can be configured such that data contributors 12 can be anonymous or not as they wish. With previous data gathering techniques, anonymous data would likely be highly suspect. However, the above-mentioned data correlation functionality makes even anonymous and rumored data valuable input to the correlation process.

Identity confirmation was traditionally an additional cost burden on data contributors 12. In the past, data gatherers would actually get to know data contributors 12 by developing a real time person-to-person relationship and then by doing subsequent follow-up research on the funding organizations. In the current economy that is no longer practical because of the much larger number of investors. Other techniques that have been used also required individuals to provide identity information or to complete complicated procedures to obtain and use secure passwords.

To address these identity issues, the system 10 allows for no identity information to be captured while still being a contributor 12. For example, an individual can start from scratch and contribute valuable data in a very short period of time without providing identity information. The system 10 can also provide an optional identity capture by way of an email address which can be used if the data contributor is willing to consider providing additional information or would like to receive information on the aggregate information for this or other transactions. Such an email address could itself be anonymous, i.e. if the address does not include the contributor's name. In this way, additional contact can be established while not breaching identity confidence. As such, it can be appreciated that the system 10 can be adapted to suit the preferences of individual users, and such data and information can be securely stored by the system 10 in the client data 36 in order to maintain contact with previous contributors.

The system 10 therefore provides an easy-to-use process to obtain categories of identity information from contributors 12. In past techniques, the identity and accuracy of contributors was established with real time voice or face-to-face communication. The system 10 described herein provides simple input methods (see screen shots described below) to obtain information on the role of the data contributor 12 in the exit transaction. For example data contributors 12 who wish to remain anonymous can provide additional information for example that they were a shareholder, employee, professional advisor or heard this information second or third hand. This additional data is used to weigh the accuracy of the data when calculating the correlated result and confidence interval.

It has also been recognized that one of the challenges in gathering exit transaction values in the current economy is that the vast majority of transactions, and most significantly the smaller transactions, are often covered by a non-disclosure agreement (NDA). The system 10 can be configured to provide a mechanism for data contributors 12 to be comforted by the security inherent and obviously displayed in the system 10 and by their opportunity to obtain an NDA from the organization associated with the system 10, quickly and easily.

For example, the system 10 may provide several options to deal with the confidentiality problem, including the option to: a) submit information anonymously, b) provide identity and trust the data gatherer with the information, and c) provide identity and receive a fully executed NDA quickly and easily—usually within a minute. It can be appreciated that different data contributors 12 could therefore select different confidentiality options.

For example, some data contributors 12 which have only received rumored information may be happy to pass it along without concern for their identity because they are not covered by a non-disclosure agreement. Other data contributors 12 may submit the data because the system 10 has provided them with information on the reputation and trustworthiness of the organizations behind the system 10. Other data contributors 12, who may actually sign a non-disclosure agreement, can also obtain an NDA back from the system 10 quickly and easily, e.g., by selecting an option during the data contribution process, or if they wish in advance. The system 10 can also reduce the probability that after an NDA is requested it will not be completed, and the data not be provided due to the time delay and burden of obtaining, reading, signing and returning the NDA by providing an immediate NDA and online signing ability.

In addition to address identity issues, the system 10 is also configured to address potential security concerns. For example, the system 10 can be designed to be as secure as financial institution websites, e.g. by incorporating a secure sockets layer (SSL), digital certificates and other cryptographic web-based security. The system 10 may therefore be configured to utilize encryption and authentication technologies and can prominently display the fact that the data is secure both during transmission and storage. This will provide further comfort to individuals who are concerned about their non-disclosure obligations.

As discussed above, today it is most likely that no single individual who is willing to make a data contribution has all of the available information. It is possible that they had the information at one point in time but because of imperfect record keeping no longer have this information available.

The system 10 also provides a way to access the more detailed information most likely available from employees of the company prior to the exit transaction. The system 10 also addresses another challenge with gathering complete datasets in the current economy. The individuals with the most complete information on the company's history will most be likely under an NDA. The system 10 may therefore be designed to first capture the most sensitive single data point—the exit valuation. In many cases this will be done relying on social media, crowd knowledge and rumored data. Once the system 10 has captured and correlated the exit transaction value, and possibly some of the other high level methods, it will often be possible to obtain the rest of the detailed information from individuals who were employed at the company prior to the transaction, and may be party to an NDA. They will be more likely to share the non-confidential information once they appreciate that the data that is most securely protected by the NDA has already been obtained by the system and they are only providing less sensitive information not specifically covered by the NDA 10.

The system 10 can be utilized by a data gathering organization in various ways depending on the nature of the information being gathered, the target data contributors 12, the geographical location in which it is used, and the immediate application of the system 10. The system 10 may also initiate the data gathering process in various ways.

The system 10 is unlike legacy processes which relied on a one-to-one communication between people who had previously established a relationship. The relationship was necessary to obtain the commitment to invest the amount of time required to complete previous data gathering methods. Previous systems relied on a data collection organization getting to know one a small number of people who then had the data on exit transactions. In the past, when most of the exit data was gathered by a venture capital funds, there may have only been a few hundred people in a country that were necessary to know to gather most of the data on venture capital back exit transactions. Today, the number of active angel and friends and family investors is typically much larger than the number of venture capital funds. These individuals are extremely difficult to identify and many of them actively protect their anonymity.

The system 10 can initiate the data gathering process by, for example, many-to-many interactions where the individuals are not known to each other. For example, one popular way to reach individual angel investors is through angel groups and associations. These organizations and groups may not have the resources to complete the surveys using the old methods, but do likely have an interest in better understanding how this part of the economy operates and how angel investing returns can be improved. Some of these groups have tried to extract data from angels using previous exit data collection methods but these have not been successful in generating statistically valid data sets because of the problems described earlier (principally the lack of motivation and the large amount of time required to complete spreadsheet style data collection surveys). Due to the system's structure, it can receive tiered data input from large numbers of unknown data contributors 12. Unlike earlier techniques, the system 10 does not require any one individual to have all of the data on a transaction.

Therefore, the system 10 can leverage relationships with organizations and groups who know the identity of many angel investors or entrepreneurs. The groups and organizations may send periodic polls to their members, using email and web-based technologies, to elicit data contributions. In another example, a mobile-suitable web application or free mobile app can be provided through such an organization and group to create a channel between the system 10 and the potential data contributors 12. The system 10 is also electronically-based and can be accessed through all of the modern communication channels making it easy for the groups and organizations to request, and obtain high participation rates in the data collection process. Moreover, the tiered data structure, and immediate, low time commitment for data capture should result in much higher participation rates.

Another example of an initiation process for data gathering, includes a gameification aspect used to generate real-time data contribution, e.g., at group gatherings or within social media groups. For example, angel investor annual meetings often including as many as 500 investors in one room. Entrepreneur conferences can be even larger. Using a gameification element of the system 10, it is possible to engage the entire audience to contribute exit transaction data in real time. Because virtually everyone in the audience will have either a smart phone, tablet or laptop, individuals will be able to make data contributions in short order. The real-time nature of the system 10 can also provide instant feedback which can be presented on the electronic screens at the gathering to show the response rate from the audience and thereby generate more excitement and competition in submitting additional data. Gameification can also be used to motivate entrepreneurs and investors to contribute data by providing a scoring system, or contest, to publically disclose the exit accomplishments of entrepreneurs and investors by describing those who have achieved the largest number of exits, highest value exits, highest return on investment (multiple), highest internal rate of return (IRR), shortest time exits or similar metrics. These can be compared and presented by type of company, year, for all time, by region, country and/or for the entire world.

It can be appreciated that exit data is typically not remunerated, which makes it difficult to motivate the people who have the data, to report the data. The gameification application using the system 10, can also motivate entrepreneurs, managers, shareholders and investors to submit exit data. By gameifying a request for data capture, data is typically captured from a much larger percentage of the available contributors 12 due to the potential for a reward. The gameification can provide a range of rewards (or awards) and recognitions for the people who submit first, or submit the most accurate or even the most exit data, to name a few examples.

In another example, organic searches, paid advertising, and social media can also be used to initiate data contributions from investors and entrepreneurs. The enormous, accessible, audiences on social media platforms like Facebook, LinkedIn, blogs, Twitter can all be presented with an appeal to contribute exit data, possibly incorporating gameification to enhance participation.

In addition to initiating the contact made with potential data contributors 12, the system may also have different ways of initiating the collection of particular data sets for particular transactions, with some processes being initiated based on knowing a particular transaction exists, but not having sufficient data (or data at all), or in general requesting any data known to a particular contributor 12.

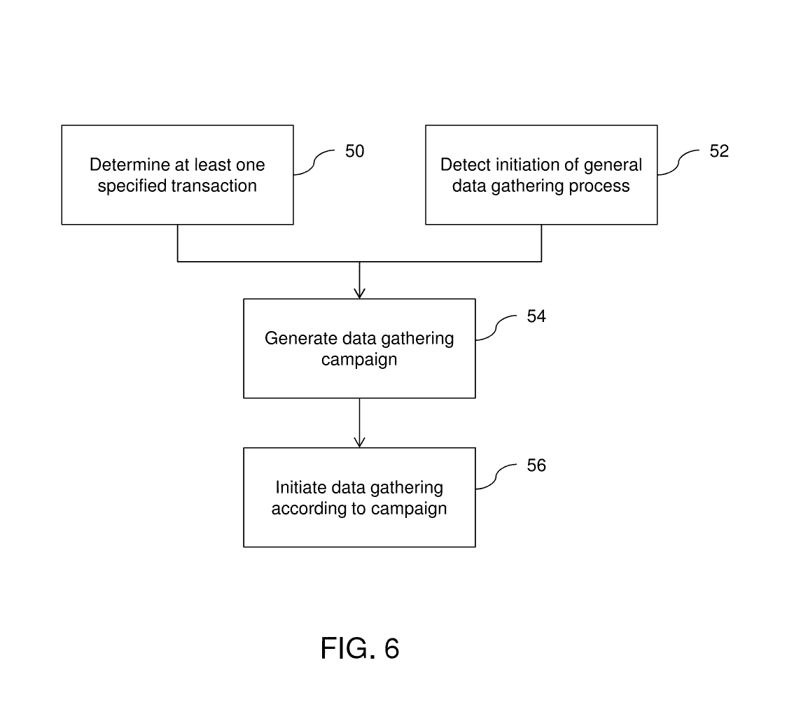

FIG. 6 is a flow chart illustrating operations that may be performed in a data gathering initiation. At 50 the system 10 determines at least one specified transaction (e.g. specified by the organization running the system 10—a data gathering entity) and/or may detect the initiation of a general data gathering process at 52 (e.g. the initiation of general data gathering through an organization or at a conference without specifying a particular transaction). The system 10 may then be used at 54 to generate a data gathering “campaign” which provides a methodology for contacting the potential data contributors 12. For example, the campaign may include a series of screens generated for a web or app-based data gathering process that is to be presented electronically to the user. The campaign may also include aspects of gameification and any awards or rewards associated therewith. The system 10 is then used at 56 to initiate the data gathering process according to the campaign.

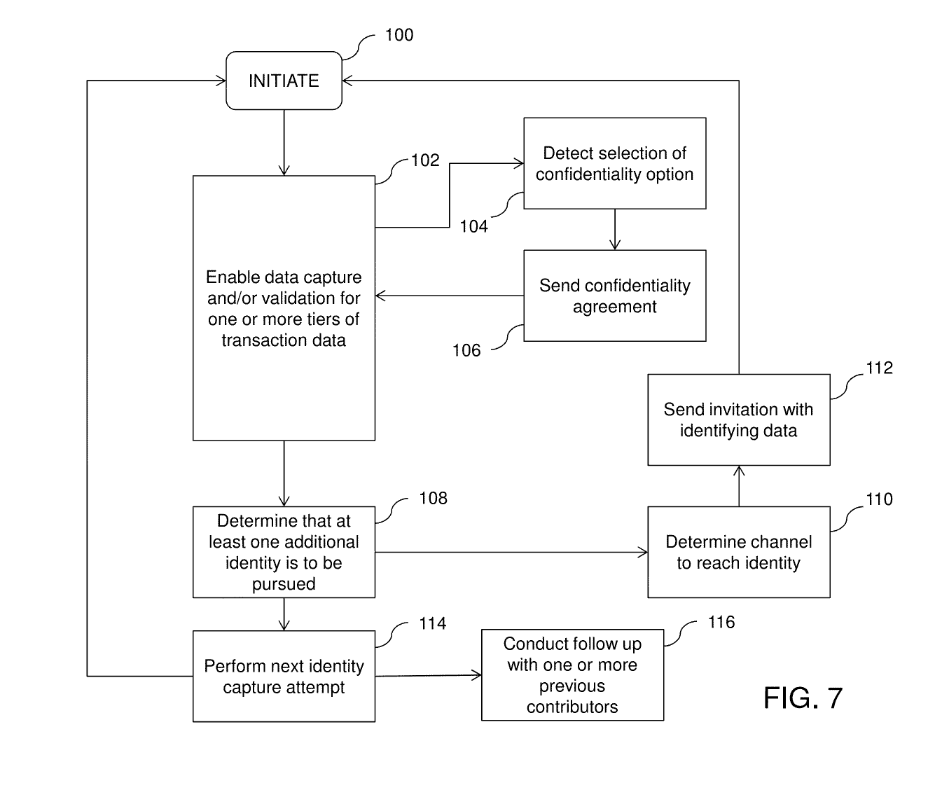

Turning now to FIG. 7, an example of a data gathering process executed by the system 10 is shown. At 100 the data gathering process is initiated and in this example assumes that a first data contributor 12 is reached and proceeds on that basis. However, it can be appreciated that the system 10 would be configured to handle multiple data contributors 12 in parallel. The initiation of the process may include, for example, the receipt of a communication or the entry into a browser or app-based user interface which provides options to the user to enter information. At 102, the medium being used to capture the data enables new data regarding an exit transaction to be entered and/or previously submitted data to be validated (e.g. as shown in FIG. 5).

The user interface being presented includes, in this example, an option to have a confidentiality agreement (e.g. NDA) executed with respect to the submission of the exit data. In the example shown in FIG. 7, the system 10 detects selection of such an option at 104, and sends a confidentiality agreement to the user at 106, e.g. via the user interface in which the selection was made. It can be appreciated that the agreement could also be sent using any other suitable communications channel, such as an email. Once the data capture process and, optionally, confidentially provisions are completed, the medium being used to gather the information determines at 108 that the data contributor 12 has identified at least one additional identity to be pursued. A suitable channel for reaching that individual is then determined by the system at 110, e.g. by searching social media pages, known organizations, or by collecting information from the data contributor 12. An invitation to participate in the data gathering process is then sent to the individual(s) at 112 at which point they may initiate an iteration of data gathering.

The system 10 then continues to perform the next identity capture attempt, e.g. by contacting a further user or processing additional data that is provided asynchronously (e.g. in a filled-form sent at an earlier time). Subsequent to a plurality of iterations, the system 10 may also execute one or more follow up operations at 116 to reach out to previous data contributors 12. For example, the system 10 could reward contributors 12 when the entire content, with all tiers is completed. The system 10 may also contact previous contributors 12 to make further attempts to gather or validate data. For example, an initial contributor may be reluctant to provide more than Tier 1 data, but after someone else has contributed data at a lower tier, that contributor 12 may be comfortable validating the submissions of others and therefore following up with that individual could be very valuable.

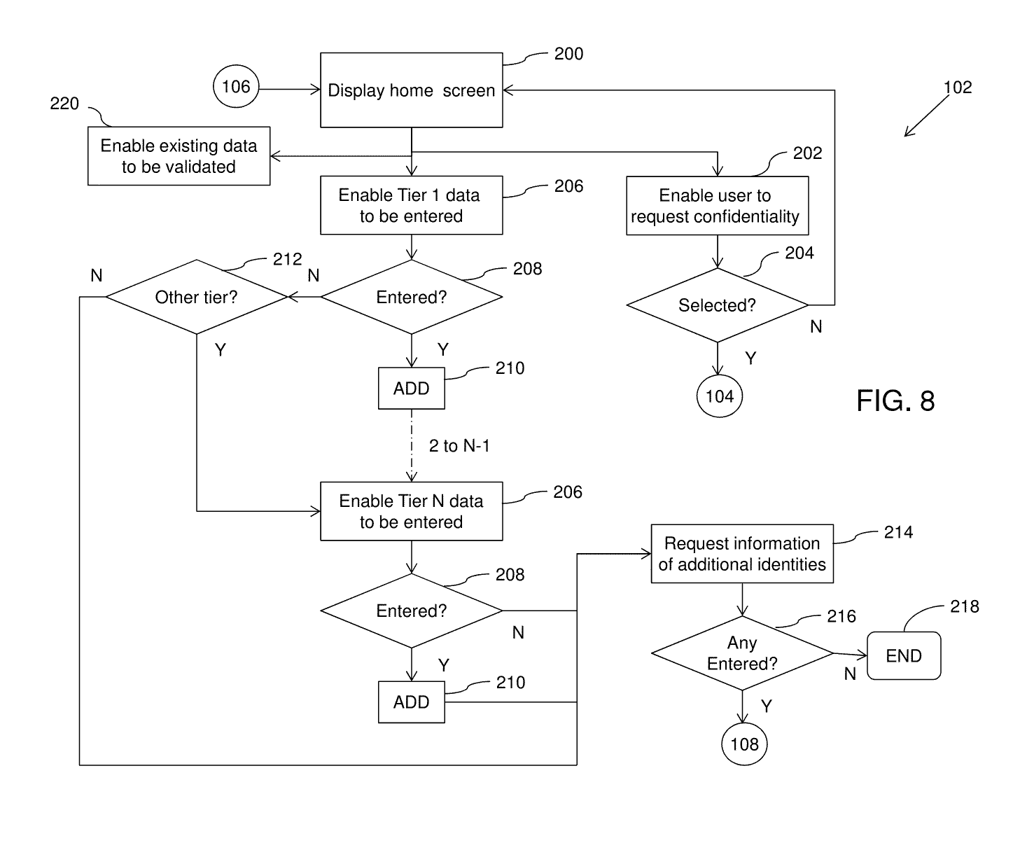

FIG. 8 illustrates additional detail regarding operation 102 shown in FIG. 7. Turning now to FIG. 8, in the example shown, a home screen or other “main” page is displayed at 200. As seen in FIG. 8, the home screen may be a landing page after various procedures such as subsequent to the provision of a confidentiality agreement at 106 (see FIG. 7). From the home screen, various options can be presented to the user. At 202, the system provides the user with the ability to request a confidentiality agreement and determines at 204 whether or not this option has been selected. If so, the process may proceed to operation 104 shown in FIG. 7. The home screen may also enable existing data to be validated by the user at 220. For example, data provided in other tiers may be made available to the user for them to review and validate. The home screen also enables the Tier 1 data to be entered at 206, to begin a process of enabling the user to proceed stepwise through the exit transaction data.

At 208, the system 10 determines if the Tier 1 data has been entered and if so, adds this data to the database 18 at 210. If the Tier 1 data is not entered or is otherwise by passed, the system 10 determines if the user is attempting to enter data in another tier at 212. If not, the user has chosen to end the data gathering process and the system 10 requests additional information for additional identities at 214. If the user intends on entering data for another tier, the process shown in operations 208-212 is repeated until a final or “Nth” tier. Whether or not the data in the Nth tier is not entered, the data gathering process ends by requesting the information of additional identities at 214. The system 10 determines at 216 if any such identities are entered. If not, the process ends at 218. If so, the process proceeds to operation 108 shown in FIG. 7. It can be appreciated that the flowchart shown in FIG. 8 is illustrative only and may be configured in different ways. For example, the home screen may instead present a single page for entering data for all tiers rather than stepping the user through the different tiers. Also, the ability to validate existing data may be presented at the end of the process instead of from the home screen.

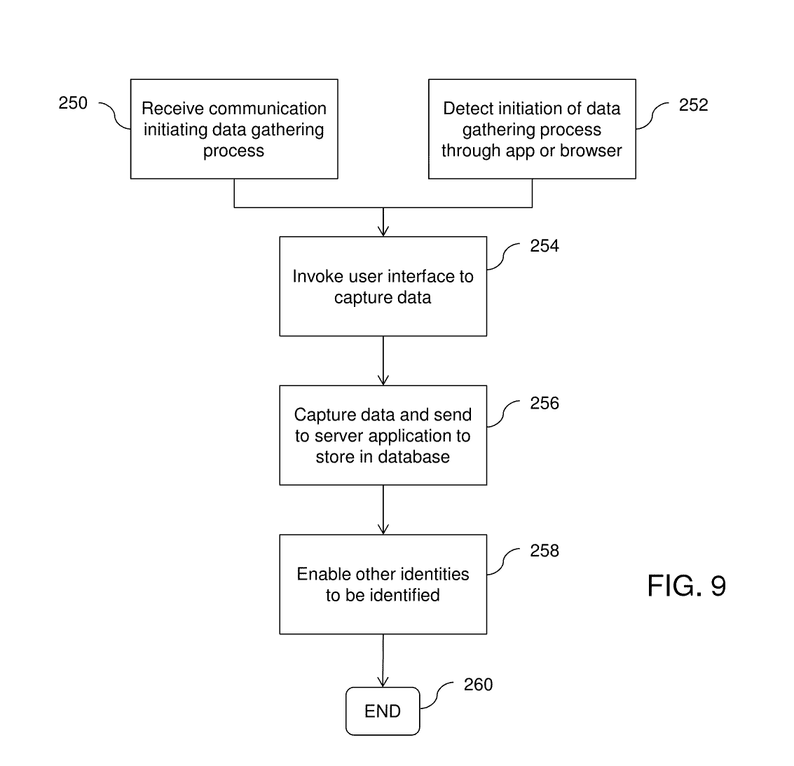

Turning now to FIG. 9, operations that may be performed by the client browser or app are shown. The process may begin at 250, wherein the user device 24 receives a communication initiating the data gathering process (e.g. an update to social media, an email, an instant message, an alert in an app, etc.), or detects initiation of the data gathering process through an app or browser by the user at 252. Once the data gathering process has been initiated, a user interface for capturing data is invoked at 254 (e.g. client application or browser 26), and the data is captured and sent to the server application 30 at 256, e.g. according to the exemplary operations shown in FIG. 8. The app or browser 26 may then enable other identities to be identified at 258, and the process ends at 260 once the user's participation is no longer needed.

It can be appreciated that the user device 24 may be contacted at a later time regarding the previously executed data gathering process, e.g. as a follow up or to request additional data or identities.

It can also be appreciated that the system 10 can be configured to allow the user to select various follow up options, such as an option requesting the system 10 to follow up for information the user does not currently have (e.g. additional identities, particular values etc.). Therefore, the system 10 can be configured to save not-yet-completed data forms from data contributors 12 to both allow for an opportunity to follow up and for the user to obtain the most accurate information without being burdened at the time they are engaged.

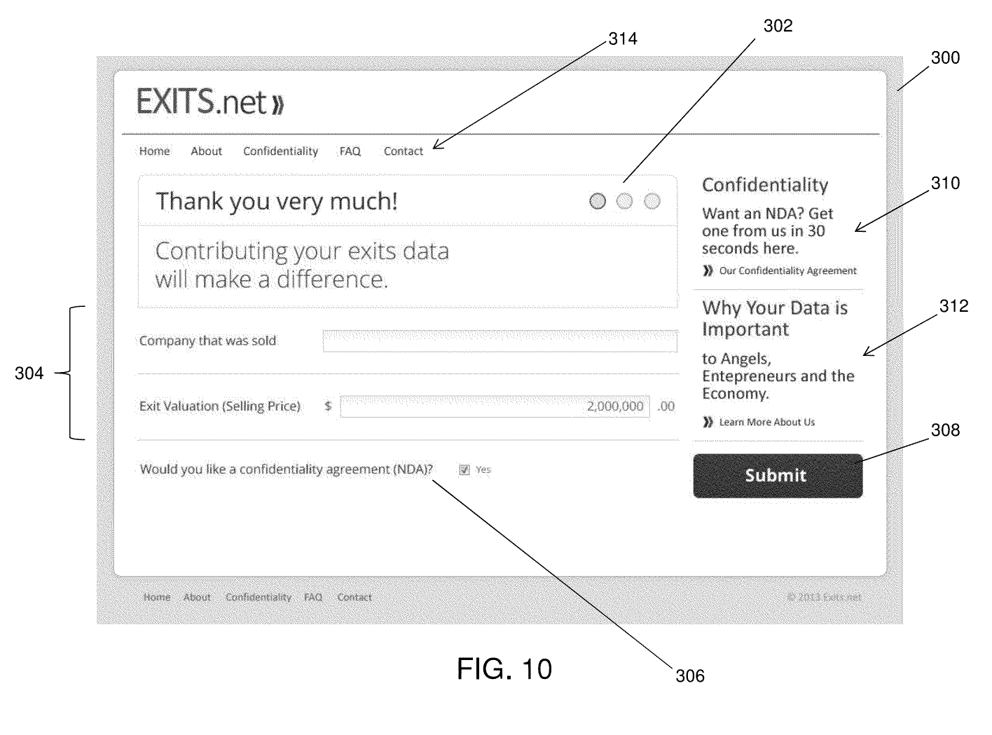

Turning now to FIG. 10, a screen shot of a user interface 300 for capturing exit transaction data is shown. The user interface 300 includes a first data input portion 302, which in this example includes a first set of data entry elements 304 for obtaining Tier 1 data, for example, the name of the company and the exit valuation. The user interface 300 also includes a confidentiality option 306, which in this example includes a check box to allow the user to request a confidentiality agreement (i.e. NDA as shown in FIG. 10) upon selecting a “submit” button 308.

The confidentiality agreement may be reviewed by the user by selecting an NDA information portion 310. In this way, the user can peruse the NDA prior to initiating the process to obtain and execute such an agreement from the system 10. The user interface 300 may also include, as shown in FIG. 10, an information selection portion 312, which may be selected in order to find out more information behind the campaign and/or data gathering organization, information regarding a purpose for the data gathering, etc. The user interface 300 may also include other menu items, links or “controls” 314, such as a home link, an “about” option, a “confidentiality” option (e.g. to link to the same information behind the NDA information portion 310), frequently asked questions (FAQs), and contact information, to name a few.

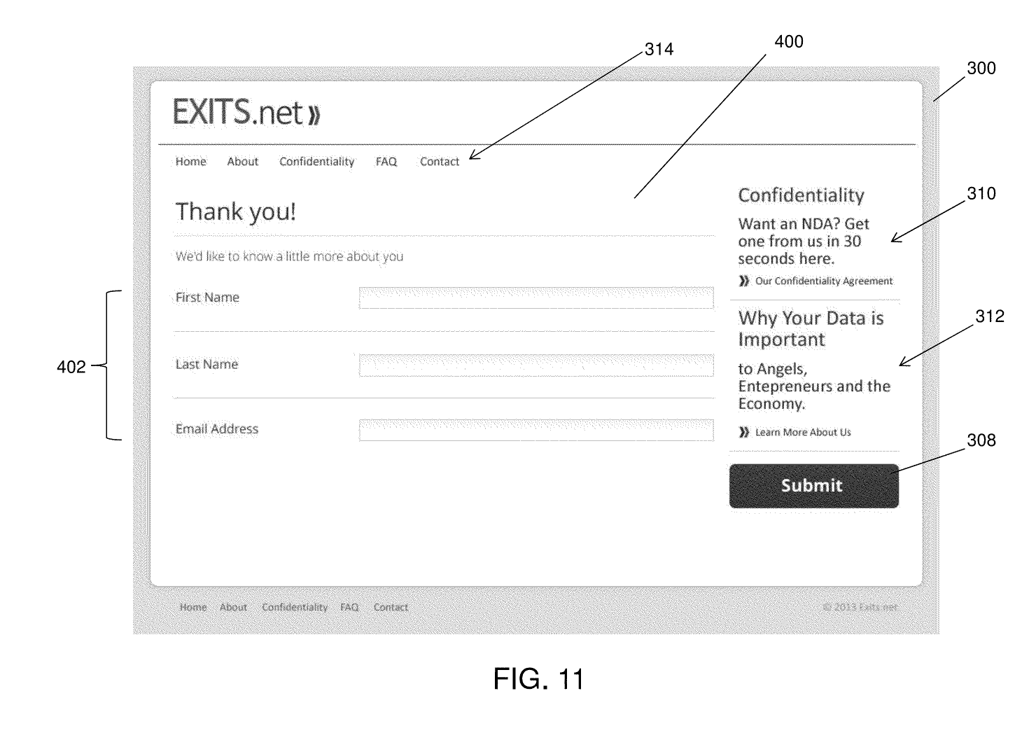

FIG. 11 illustrates another screen shot of the user interface 300 in which an example set of Tier 2 data is requested. The user interface 300 is therefore updated to include a second data input portion 400, which includes a second set of data entry elements 402 for obtaining the Tier 2 data, in this example, the first name, last name, and email address of the data contributor 12, i.e. “identity” information.

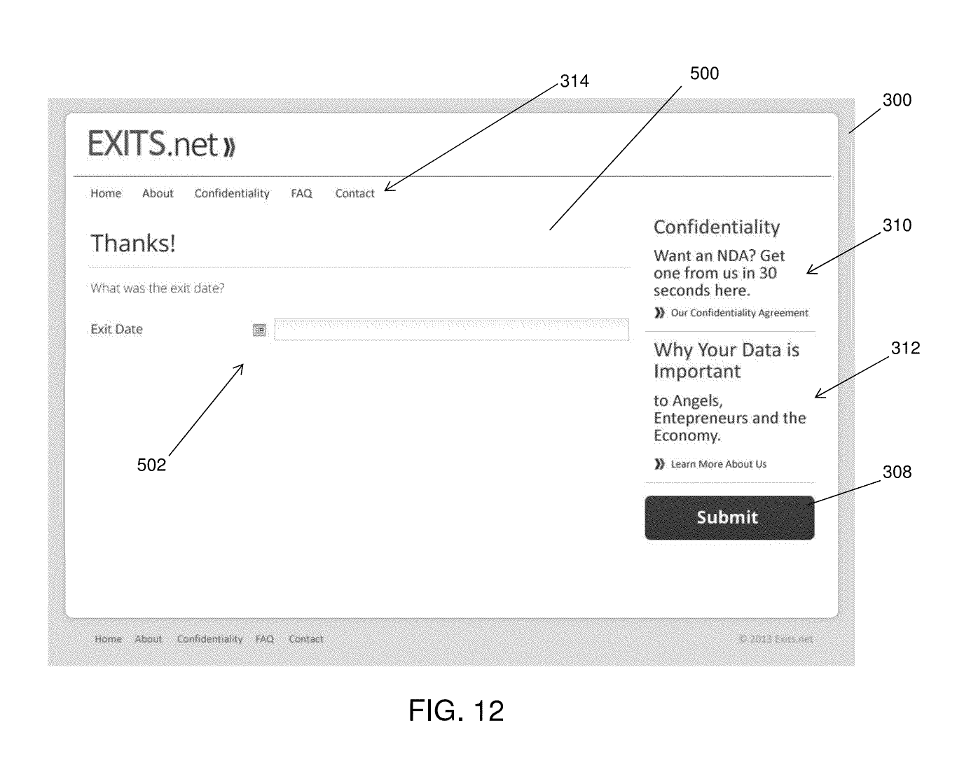

FIG. 12 illustrates yet another screen shot of the user interface 300 in which an example set of Tier 3 data is requested. The user interface 300 is therefore further updated to include a third data input portion 500, which includes a third data entry element 502 for obtaining the Tier 3 data, in this example, an exit date for the transaction. It can be appreciated that, as shown in FIG. 12, the data entry element 502 may include a date-selection-calendar or other mechanism (e.g. separate day-month-year input boxes or drop down lists) to facilitate consistent entry of a desired date format.

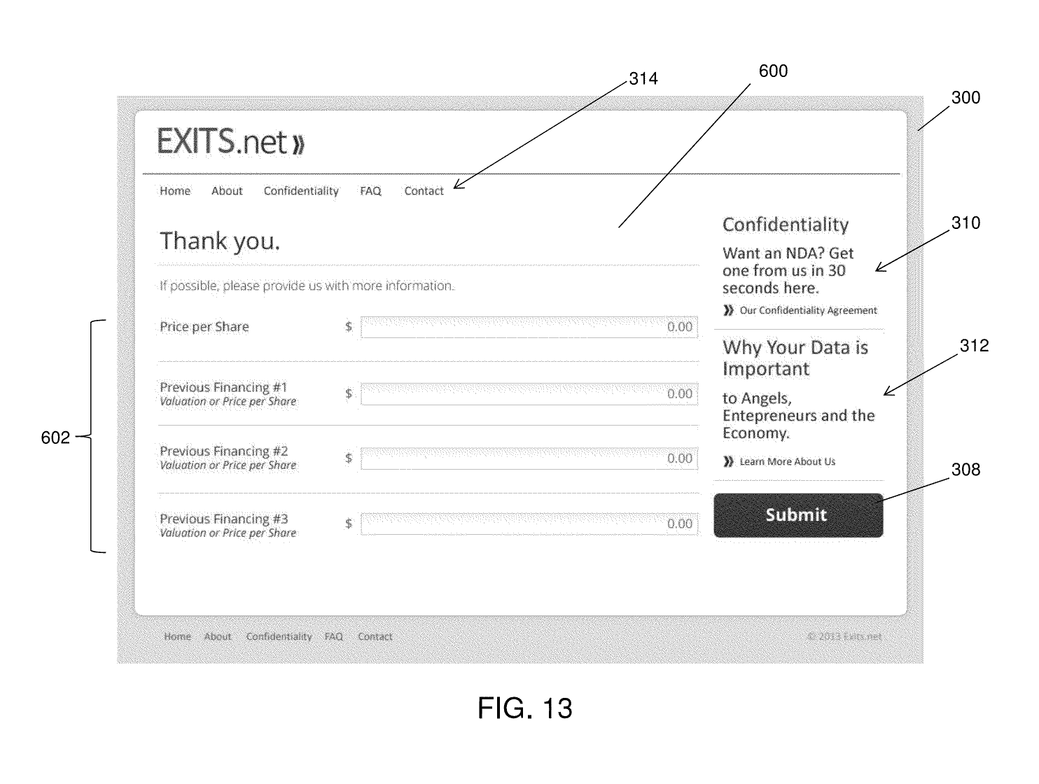

FIG. 13 shows yet another layer in which the user interface 300 requests Tier 4 data. In the example shown in FIG. 13, the user interface 300 is further updated to include a fourth data input portion 600, which includes a fourth set of data entry elements 602 for obtaining the Tier 4 data. In this example, the fourth set of data entry elements 602 correspond to a price per share, previous financing #1 (valuation or price per share), previous financing #2 (valuation or price per share), and previous financing #3 (valuation or price per share). It can be appreciated that the Tier 4 data being requested in FIG. 13 is illustrative only and may include more or fewer data entry elements 602 and/or options to enter additional related information.

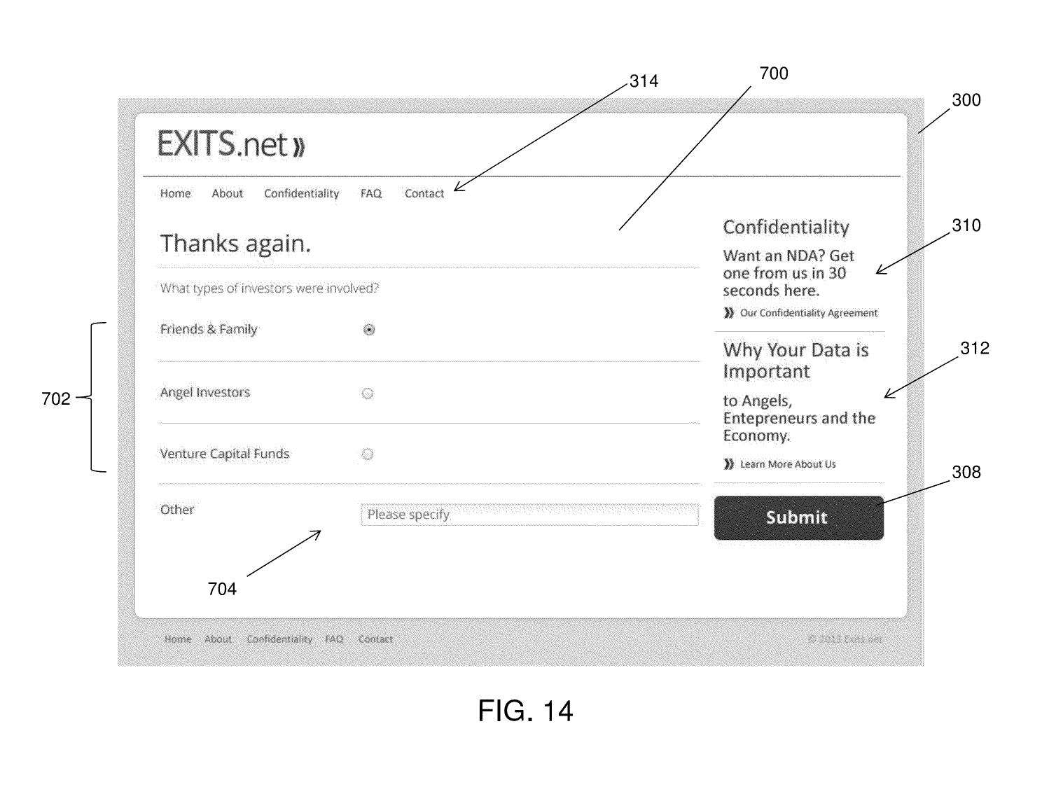

FIG. 14 illustrates yet another screen shot of the user interface 300 in which an example set of Tier 5 data is requested. The user interface 300 is further updated to include a fifth data input portion 700, which includes a fifth set of data entry elements 702. In this example, the fifth set of data entry elements 702 includes options for selecting types of investors from predetermined types, or to enter other types.

It can be appreciated that the user interface 300 provides manageable requests for the data in stages, tiers or layers, to allow the user to go as “deep” as they can or want to.

It will be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the transaction data capture system 10, data correlator 20, transaction database 18, data requestor 22, user device 24, etc., any component of or related thereto, or accessible or connectable thereto. Any application or module herein described may be implemented using computer readable/executable instructions that may be stored or otherwise held by such computer readable media.

The steps or operations in the flow charts and diagrams described herein are just for example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as outlined in the appended claims.

1. A method of obtaining exit transaction data, the method comprising:
providing a first user interface for entering the exit transaction data from a first source;
enabling entry of a first portion of the exit transaction data;
enabling at least one additional portion of the exit transaction data to be obtained from a second source using a second user interface;
receiving a first entry corresponding to the first portion of data;
receiving at least one second entry corresponding to the at least one additional portion of the exit transaction data; and
storing the first entry and at least one second entry in association with a particular transaction.

2. The method of claim 1, wherein first and second entries are part of a plurality of tiers of the exit transaction data.

3. The method of claim 1, further comprising receiving a plurality of responses for one or more of the first and second entries.

4. The method of claim 3, further comprising performing at least one statistical process to correlate the plurality of responses.

5. The method of claim 1, further comprising following up with at least one of the first and second source to request at least one other additional portion of the exit transaction data.

6. The method of claim 1, further comprising enabling entry of an identity of at least one additional source.

7. The method of claim 1, further comprising enabling at least one previously received portion of the exit transaction data to be validated by the first source or the second source.

8. The method of claim 1, further comprising enable a confidentiality agreement to be requested by the first or second source.

9. The method of claim 8, further comprising sending the confidentiality agreement to a requesting source.

10. The method of claim 1, wherein the exit transaction data comprises a plurality of the following data: company name, exit valuation, identity of source, contact information for source, exit date, price per share, previous financing information, and type of investor.

11. The method of claim 1, wherein the first and second entries are received via any one or more of the following data capture channels: webpage, mobile application, email, SMS, instant messaging, and social media.

12. The method of claim 1, wherein at least one of the first user interface and the second user interface is provided by a mobile application or browser accessible to the first and second sources.

13. A system for obtaining exit transaction data, the system comprising a processor, at least one memory element, and at least one communication interface, the at least one memory element comprising computer executable instructions executable by the processor to:
provide a first user interface for entering the exit transaction data from a first source;
enable entry of a first portion of the exit transaction data;
enable at least one additional portion of the exit transaction data to be obtained from a second source using a second user interface;
receive a first entry corresponding to the first portion of data;
receive at least one second entry corresponding to the at least one additional portion of the exit transaction data; and
store the first entry and at least one second entry in association with a particular transaction.

14. The system of claim 13, wherein first and second entries are part of a plurality of tiers of the exit transaction data.

15. The system of claim 13, further comprising instructions for receiving a plurality of responses for one or more of the first and second entries.

16. The system of claim 15, further comprising instructions for performing at least one statistical process to correlate the plurality of responses.

17. The system of claim 13, further comprising instructions for following up with at least one of the first and second source to request at least one other additional portion of the exit transaction data.

18. The system of claim 13, further comprising instructions for enabling entry of an identity of at least one additional source.

19. The system of claim 13, further comprising instructions for enabling at least one previously received portion of the exit transaction data to be validated by the first source or the second source.

20. The system of claim 13, further comprising instructions for enable a confidentiality agreement to be requested by the first or second source.

21. The system of claim 20, further comprising instructions for sending the confidentiality agreement to a requesting source.

22. The system of claim 13, wherein the exit transaction data comprises a plurality of the following data: company name, exit valuation, identity of source, contact information for source, exit date, price per share, previous financing information, and type of investor.

23. The instructions for of claim 13, wherein the first and second entries are received via any one or more of the following data capture channels: webpage, mobile application, email, SMS, instant messaging, and social media.

24. The system of claim 13, wherein at least one of the first user interface and the second user interface is provided by a mobile application or browser accessible to the first and second sources.

25. A computer readable storage medium comprising computer executable instructions for obtaining exit transaction data, the computer executable instructions comprising instructions for:
providing a first user interface for entering the exit transaction data from a first source;
enabling entry of a first portion of the exit transaction data;
enabling at least one additional portion of the exit transaction data to be obtained from a second source using a second user interface;
receiving a first entry corresponding to the first portion of data;
receiving at least one second entry corresponding to the at least one additional portion of the exit transaction data; and
storing the first entry and at least one second entry in association with a particular transaction.
